(19) United States
(12) Patent Application Publication
(10) Pub. No.: US 2026/0330944 A1
(43) Pub. Date: Oct. 22, 2026

(54) Systems and Methods for De-escalation and Interdiction of Threats

(71) Applicant: Intellishot Holdings LLC, Delray Beach, FL (US)

(72) Inventor: Steven Wayne Goldstein, Delray Beach, FL (US)

(21) Appl. No.: 19/649,726

(22) Filed: Apr. 16, 2026

Related U.S. Application Data
(60) Provisional application No. 63/789,876, filed on Apr. 16, 2025.

(51) Int. Cl. G08B 15/00; G06V 10/10; G06V 10/25; G06V 10/764; G06V 20/52; G06V 40/16; H05B 47/125

(52) U.S. Cl. CPC G08B 15/004; G06V 10/17; G06V 10/25; G06V 10/764; G06V 20/52; G06V 40/161; H05B 47/125

(57) ABSTRACT

A system for influencing behavior of a subject at a distance includes a deployable apparatus positioned remotely from the subject, at least one subsystem configured to obtain information relating to an environment that includes the subject, a controllable energy source configured to produce emissions, and an emission delivery arrangement configured to project the emissions toward a location associated with the subject. Control circuitry operatively coupled to the at least one subsystem and the controllable energy source determines, based at least in part on the obtained information, whether emission of the emissions is permitted and, when permitted, regulates one or more characteristics of the emissions during projection. The emissions are delivered without physical contact and are regulated to produce an effect on the subject while satisfying predetermined safety or operational constraints.

### REFERENCE TO RELATED PATENT APPLICATION

The present application claims benefit of U.S. Provisional Application No. 63/789,876, filed on Apr. 16, 2025, the contents incorporated by its entirety.

### TECHNICAL FIELD

The present disclosure relates generally to systems and methods for non-contact behavioral interdiction and remote subject compliance. More particularly, the disclosure relates to rule-governed, safety-constrained systems that integrate sensing, artificial intelligence, computer vision, and controlled energy emission technologies to influence subject behavior at a stand-off distance without physical contact

The present disclosure further describes techniques for acquiring situational information, identifying and tracking a subject, determining permissibility of energy emission in accordance with operational rules and safety constraints, and dynamically regulating emission characteristics during delivery toward selected regions associated with the subject. In various embodiments, controlled photonic emissions may be delivered in a manner sufficient to produce a non-lethal sensory stimulus capable of inducing behavioral modification while limiting tissue damage and preventing unintended exposure.

### BACKGROUND

Directed energy countermeasures have been fielded for decades. These include photonic, RF, microwave, and millimeter wave solutions. As viable as the directed energy solution would appear to solve for, the limiting factor has always been aiming, targeting, persistent tracking and a safe level of energy emissions to induce an efficacious behavior modification while ensuring dependable performance without the risk of collateral damage. This has not been achievable in the past due to limitations in computer vision systems caused by latency, frame rates as well as AI inferencing speeds capable of processing multiple frames of high-resolution video content at ultra-high speeds throughput. Adding to the SWaP (Size, Weight, and Power) problem, portability has been challenging and has all but eliminated the possibility of a smart handheld appliance.

In some deployments, the deployable apparatus described herein is carried by security personnel or other authorized users to physically aim at a bad actor to serve as a non-lethal substitute to a firearm in specific application as well as offer a broader range of force multiplier countermeasures. Typically, laser beam emissions powered by a handheld device is at best wildly variable in terms of contacting and maintaining contact on the target. One only needs to hold a handheld pencil sized laser pointer to illuminate a target 25 feet away who is standing still, the laser beam will be erratic in position. Should the target be moving, it becomes unlikely the laser beam can be maintained on the subject. This is at the core, the underlining weakness of directed energy solutions, as they can easily be misdirected missing the subject and, worse, can cause damage or pain to an innocent bystander.

Aiming, targeting and persistent tracking errors are further exacerbated when adrenalin is released. The net result is the photonic energy is either too modest to induce pain based on target distance and variability, too aggressive which will result in permanent tissue damage, loss of sight or visual acuity, or even worse resulting in collateral damage as the laser beam will likely hit an innocent bystander downrange of the bad actor or subject of interest.

The present disclosure describes a series of diametrically opposed interdiction use cases. In a first operating state, a protocol is enabled to limit the functionality of the appliance. In this example all or selected wavelengths of laser emissions are prevented from targeting the cornea. Although the emissions of the appliance are deemed safe under the FDA and EIC guidelines, the managing party of the appliance wants to prevent the possibility of any psychological or physiological impact based on depositing emissions to the eye. Under this operating state, an operator could target any and all regions of the anatomy including the nose, mouth, neck, chest, hands, arms, legs and back of than the eye. During operation in this state, the AI Computer Vision system cooperates with the control circuitry to prevent the deployable apparatus (appliance) from depositing emissions within the periorbital region, including the cornea.

In a second operating state, a managing entity permits use of the deployable apparatus with its full functionality when the engagement circumstances warrant such use. During a security response engagement, an operator may select the cornea of a subject as a target region with the objective of de-escalating the situation. The operator may determine that the subject presents a level of threat requiring immediate interdiction and that directing emissions toward the corneal region is an appropriate response under applicable protocols. In another example, the operator may initially directed emissions toward non-ocular regions, such as the hands of the subject; however, if such engagement fails to de-escalate or alter the subject's behavior, the operator may subsequently determine that directing emissions toward the eyes is required.

Certain use cases may involve a transition between the foregoing operating states. For example, an operator may initially elect not to direct emissions toward the cornea, but subsequently encounter a situation in which the subject is observed to be brandishing a firearm. In such a circumstance, the object recognition capabilities of the AI Computer Vision system detect the presence of the weapon and trigger a change in applicable rules or protocols that permit emission toward the corneal region. Regardless of the operating state, the system is configured to ensure that emissions are deposited only on the subject and not on other individuals who may be present, including potential innocent bystanders.

For a directed-energy-laser (DEL) interdiction system to operate responsibly and dependably, the system described herein integrates an ultra-high-speed artificial-intelligence Computer Vision (CV) capability that performs anatomical landmark analysis and object detection, coupled with an electromechanical optical subsystem interfaced to the laser emitter. In operation, combined movement of a handheld deployable apparatus and a human subject at a distance of approximately 25 feet can result in targeting errors on the order of 1-3 centimeters within a time interval of approximately 5 milliseconds, even when both parties attempt to remain stationary. This inherent human movement variability introduces significant uncertainty for conventional targeting and tracking approaches to maintain precise targeting confidence. Such uncertainty is further exacerbated when either the operator or the subject is in a heightened state of stress or fear.

To reduce the likelihood of misplaced, harmful, or undereffective deposition of emissions on a subject's anatomy, or inadvertent exposure of an innocent bystander, the system described herein is configured to achieve a high degree of confidence in operational performance. In particular, the total end-to-end throughput time—from camera image acquisition through decision generation and system control—does not exceed approximately 5 milliseconds. Maintaining such throughput is important for inducing behavioral change safely and with the required efficacy. Electronic and electromechanical contributors to the overall throughput include camera frame rate and latency, central processing resources and data-bus configuration, a neural processing unit (NPU), time-of-flight (ToF) sensing rate, variable-optics response time, galvo or micromirror response time, laser pulse rate and repetition rate, and video sensor array acquisition time.

In operation, the AI Computer Vision system locks onto a subject when the deployable apparatus is aimed and initialized by an operator. Targeting, distance estimation, and emission-related calculations are governed by the system, enabling persistent and continuous tracking and interdiction. As the subject moves, walks, or runs, the AI Computer Vision system generates precision aiming coordinates for a firing solution that controls the location of a directed-energy laser (DEL) beam using electronically controlled dual-axis fast-steering mirrors in combination with variable optics to optimize beam size within an area of interest (AoI) and on an anatomical region of interest (RoI).

By way of background, pain sensation is detected by specialized sensory neurons referred to as nociceptors, which respond to stimuli such as mechanical pressure, chemical signals from damaged cells, or, in the context of certain embodiments described herein, rapid thermal excitation. The process of experiencing pain includes initial signal transmission to the brain on the order of approximately 2-7 milliseconds, followed by conscious pain perception occurring on the order of approximately 100-200 milliseconds.

The present disclosure defines an emission signature comprising one or more controllable variables, which may include time on target, wavelength, emission dose, beam size, pulse duration, repetition rate, beam scanning rate, escalation or de-escalation rate, raster size, and a spatial pattern applied at a target location.

In some embodiments, the system controls a pulsed directed-energy laser (DEL) to generate an emission signature defining a stimulus profile. The beam profile may be Gaussian, and energy emission may be pulsed with adjustable energy level, repetition rate, and duty cycle. Pulsing may be controlled using processing circuitry and/or electromechanical or acoustic mechanisms, such as an optical chopper. Coupling of the DEL to a variable-optics lens enables dynamic focusing during operation. A beam-steering engine further aligns the DEL emissions toward selected locations on a subject's anatomy, including the head, arms, hands, legs, feet, or facial regions such as the nose, mouth, lips, teeth, tongue, gums, and, in some use cases, the eyes, including the cornea. Coordination of beam steering, optics, and emission parameters is referred to herein as a firing solution.

Pain sensation may result from thermal excitation of nerve cells, or neurons, particularly A-fiber nociceptors. A-fibers (Aδ) may be activated by temperature change and are associated with an initial, sharp, piercing, and localized pain sensation commonly referred to as “first pain.” C-fibers also contribute to pain perception by relaying signals associated with burning, dull, or persistent sensations, sometimes referred to as “second pain.”

In many contexts, induction of such pain sensations may be sufficient to produce a behavioral response, but uncontrolled thermal stimulation can be accompanied by permanent tissue damage, including scarring, deformation, necrosis, corneal abrasion, or loss of visual acuity. Accordingly, the system described herein incorporates mechanisms to measure and limit aggregated energy deposition so as to maintain operation within safety thresholds while achieving an intended behavioral effect.

By way of anatomical background, the cornea is the transparent anterior portion of the eye and is among the most densely innervated and sensitive structures in the human body. Central corneal nerve density is approximately 7,000 nerve endings per square millimeter, resulting in sensitivity that is estimated to be approximately 300-600 times greater than skin and 20-40 times greater than dental pulp. Such sensitivity is moderated by the corneal epithelium, the outermost layer of the eye, which typically regenerates relatively quickly following irritation or minor injury.

A specific photonic wavelength can safely activate nociceptors and cause pain by delivering radiant heat to the epithelium or epidermis, which excites Aδ- and C-fiber nerve endings.

Laser irradiation is characterized by multiple parameters, including wavelength, radiant exposure, energy concentration at a target location, and duration of exposure. Wavelength is a primary factor influencing penetration depth of optical radiation, with longer wavelengths generally exhibiting increased penetration through biological tissue. Wavelength is also associated with the magnitude of thermal effect produced by the light. Radiant exposure and exposure duration define the total dose of laser energy absorbed by tissue, which in turn influences cellular response. Another parameter affecting tissue interaction is the mode of delivery, such as continuous or pulsed emission. Wavelength further determines whether the emitted beam is visible or non-visible to the human eye.

Lasers operating in the Infrared-B (approximately 1,400 nm-3,000 nm) and Infrared-C (approximately 3,000 nm to 1 mm) wavelength ranges are primarily absorbed within anterior portions of the eye and are associated with higher maximum permissible exposure (MPE) limits than visible wavelengths (approximately 400 nm-700 nm) or Infrared-A wavelengths (approximately 700 nm-1,400 nm), which tend to be transmitted and focused onto the retina. Infrared-A and Infrared-B wavelength ranges are often referred to as “eye-safe” due to their higher exposure limits and reduced likelihood of retinal damage.

Using the AI Computer Vision system in combination with a beam-steering firing solution to deposit approximately 2 um (micrometer) wavelength emissions on the cornea, various operating examples are described herein.

In operating modes authorized by applicable protocols, the eye may serve as a region of interest for inducing pain. In many scenarios in which the system is deployed, the eyes of a subject are visible to both an operator and an integrated imaging sensor and may therefore present a readily identifiable target region. In contrast, subjects may otherwise be fully clothed or equipped with garments intended to conceal or protect other anatomical areas, such as balaclavas covering the head and face or gloves covering the hands.

Despite their accessibility, ocular regions present challenges for accurate targeting and tracking due to their relatively small size and varying distance from an operator. Accordingly, safe and effective operation requires a low-latency, high-frame-rate computer vision capability coupled with processing resources, such as a neural processing unit and central processing unit, in combination with a high-speed beam-steering system and variable-focus optics capable of maintaining alignment with a selected region of interest. In view of inherent human motion of both the subject and the operator, the total acquisition-to-interdiction firing solution is executed within a time frame of less than approximately 5 milliseconds.

By way of example, after an operator issues instructions for a subject to retreat, failure to comply may prompt the operator to initiate emission by actuating a control input. In response, the AI Computer Vision system locks onto the subject, determines subject distance, identifies a region of interest in accordance with applicable protocols, establishes an emission signature, and directs delivery of approximately 2-micrometer wavelength energy. The directed-energy emission may be non-visible, such that the subject receives no visual indication of emission prior to experiencing a thermally induced pain stimulus.

By way of example, when ocular regions are selected as a target, laser emissions may be controlled so as to raise corneal temperature from a normal range of approximately 31-37 °C (88-99 °F) to approximately 43 °C (109.4 °F), at which point a burning pain sensation may occur, as nociceptors are generally activated when temperatures exceed approximately 43 °C (109.4 °F). Pain intensity at this temperature, as measured using the Visual Analogue Scale (VAS), may increase to a level of 10 within less than approximately 1-2 seconds of emission time.

In some embodiments, the system is configured to apply thermal stimulation to the cornea without the subject being consciously aware of the temperature-increase process as it occurs. In such implementations, laser emissions may initially be delivered over facial regions at or beyond the periorbital area. Temperature changes in skin occur more rapidly than in the cornea due to the cornea's moisture content and surrounding aqueous environment, which contributes to temperature regulation of ocular tissue. When emissions are applied to facial regions, the subject may experience localized sensations in areas such as the face, nose, lips, mouth, or cheeks while corneal temperature has not yet reached the approximate 43 °C threshold. In some use cases, emissions may initially be directed to non-ocular regions to divert the subject's attention while corneal temperature increases gradually.

In certain operating sequences, corneal sensitization may be initiated by depositing a lower-dose energy emission that begins to elevate corneal temperature, with subsequent emissions applied to increase sensitivity to heat. This condition, referred to as hyperalgesia, is characterized by increased pain sensitivity in which otherwise tolerable stimuli are perceived as more intense. In some implementations, emission parameters may subsequently be adjusted to produce higher pain levels intended to elicit a behavioral response.

In additional embodiments, hyperalgesia-based approaches may be combined with distraction techniques, including delivery of laser emissions to portions of the face or other anatomical areas so that the subject's attention is directed toward localized sensations while corneal temperature approaches a threshold associated with behavioral modification.

During operation, the deployable apparatus is configured to capture and securely record engagement events. A forensics subsystem records media and operational data including video of the subject, panoramic imagery, audio information, targeting data, emission parameters, operator identification, environmental conditions, location information, system status, and performance metrics. Such data may be available in real time and may be stored locally or transmitted securely. The apparatus may be remotely deactivated or updated with revised rules or protocols, and operation may be authorized using biometric verification. In some deployments, the apparatus interoperates with other tools, such as body-worn cameras or conducted-energy devices, and supports software updates delivered over the air. Captured data may be used to demonstrate compliance with authorized operating protocols, including confirmation that emissions were not excessive or improperly applied. Recorded information is secured both at rest and in transit.

As used throughout this specification, references to pain sensation, behavioral modification, incapacitation, escalation, or subject response describe outcomes that may occur only as a result of operation of a rules-governed, safety-constrained control system. Emission characteristics, targeting decisions, emission signatures, and escalation or de-escalation behaviors are generated, limited, and supervised by one or more control modules, including an AI Computer Vision engine, a Rules and Protocols engine, and a Safety engine, operating in a closed-loop manner to enforce predefined safety thresholds, anatomical constraints, and operational policies. No embodiment described herein requires or permits uncontrolled, open-loop energy deposition, and any sensory, neurological, or behavioral effects arise solely within boundaries established by system controls and applicable exposure limits.

### SUMMARY

In one embodiment, beam location and beam size are adjustable based on a selected anatomical region of interest. By way of example, the eye contains polymodal nociceptors distributed across the corneal surface. Typical corneal dimensions include a diameter of approximately 11.5 millimeters, with thicknesses of approximately 0.5-0.6 millimeters at the center and 0.6-0.8 millimeters at the periphery. In certain conditions, such as increased subject distance or reduced ambient illumination, the accuracy with which a computer-vision system can detect and fixate on the cornea may fall below a desired confidence level for safe targeting. In such cases, the system may employ a variable-optics element to adjust beam size based on range. The computer-vision system may increase or decrease beam size to improve confidence that emissions are deposited across the intended corneal region. In various embodiments, either a single eye or both eyes may be targeted by an operator or automatically by the AI Computer Vision system.

In one embodiment, beam size is adjusted as a function of distance between the operator and the subject, as targeting confidence may decrease with increasing range. The cornea is typically approximately 12 millimeters in diameter, requiring increased targeting precision at close distances, such as approximately five feet. As distance increases, maintaining accurate targeting of the corneal region becomes more difficult. By enlarging the beam spot size at greater distances, the system may improve the likelihood of successful interdiction.

A firing solution incorporating beam steering and variable-focus optics is capable of aiming, scanning, or rasterizing a larger target area, such as an orbital socket that is approximately 35 millimeters in diameter.

In one embodiment, a rasterization technique is employed to dither laser emissions across a periorbital region or a nasal root area extending from the lower portion of the nose toward the forehead. In such examples, a time-on-target on the order of approximately 1-2 seconds may be sufficient to reach a pain intensity corresponding to a VAS level of 10. Upon deposition of emissions on the cornea, an autonomic blink reflex may occur, typically within approximately 12-40 milliseconds following stimulation. Accordingly, time-on-target and emission control are significant aspects of system operation. Stimulation may elicit both a direct response from the exposed eye and an involuntary response from the opposite eye.

In one embodiment, emissions are directed toward both eyes of a subject. Following emission deposition and eyelid closure, the subject may place both hands over the eyes in an attempt to reduce discomfort. If the subject is holding an object, such as a weapon, the subject may release the object while attempting to shield the eyes.

In another embodiment, emissions are directed toward a single eye. Following eyelid closure, the subject may place a hand over the affected eye. In such cases, an operator may leverage the subject's response by issuing instructions conditioned on continued emission or redirection of emissions toward the opposite eye.

In one embodiment, facial regions including one or more of the eyes, nose, nasal mucosa, vermillion border, lips, or mouth collectively define a region of interest encompassing at least a portion of the face. In such embodiments, a directed-energy laser is coupled with optics capable of expanding a beam to an area on the order of approximately 11 centimeters by 11 centimeters, or to a circular beam suitable for irradiating the facial region, with the beam size adjustable when a smaller region of interest is selected. Emissions deposited across facial regions stimulate nociceptors, while an emission signature is modulated by the AI Computer Vision system to remain within a safe emission level. Beam steering and variable optics are coordinated as part of the firing solution to constrain emission coverage to the facial region. During operation, the AI Computer Vision system persistently tracks the subject. If another person or animal enters the field of view, that entity is also detected and tracked to assess potential unintended exposure. Based on such assessment, emissions may be redirected or temporarily terminated to reduce the likelihood of collateral exposure.

The foregoing summary is provided to introduce aspects of the present disclosure in general terms, with additional details and exemplary embodiments described below with reference to the accompanying drawings

### BRIEF DESCRIPTION OF DRAWINGS

The present disclosure is illustrated by way of example and is not limited by the figures of the accompanying drawings, in which like reference numerals indicate corresponding elements.

FIG. 1 is a functional block diagram illustrating an exemplary embodiment of an AI Computer Vision system used to detect, identify, and track a subject and associated anatomical regions of interest.

FIG. 2 is a functional block diagram illustrating an exemplary embodiment of a forensics engine configured to record operational data, emissions data, environmental parameters, and media associated with an interdiction event.

FIG. 3 is a functional block diagram illustrating an exemplary embodiment of a rules and protocols engine configured to govern system operation based on sensor inputs, operator inputs, and operational constraints.

FIG. 4 is a functional diagram illustrating an exemplary operator interface and control configuration for interacting with a deployable apparatus (appliance), including triggers, buttons, and feedback mechanisms

FIG. 5 is a functional block diagram illustrating an exemplary safety engine configured to monitor, limit, and control laser emissions to maintain compliance with predefined safety constraints.

FIG. 6 is a functional block diagram illustrating an exemplary emission signature engine configured to define laser pulse characteristics, power levels, duty cycles, and scanning parameters.

FIG. 7 is a functional block diagram illustrating an exemplary firing-solution subsystem configured to control beam steering, focusing, and aiming of laser emissions toward selected regions of interest.

FIG. 8 is a schematic illustration of an exemplary optical subsystem including variable-optics elements, beam steering components, and laser sources.

FIG. 9 is a schematic illustration of an exemplary deployable apparatus layout showing integration of optical, sensing, processing, and control components.

FIG. 10 is a schematic illustration of an exemplary thulium (Tm) pulsed laser source used by the deployable apparatus.

FIG. 11 is a schematic illustration of an exemplary optical emission and beam-delivery subsystem associated with a pulsed laser source.

### DETAILED DESCRIPTION

The following detailed description refers to the accompanying drawings, which form a part hereof and illustrate representative embodiments and examples of the present disclosure. These embodiments are provided for explanatory purposes and are not intended to limit the scope of the disclosure. Features described in connection with one embodiment may be combined with features of other embodiments, additional embodiments may be employed, and structural, functional, or operational modifications may be made without departing from the principles of the present disclosure. The examples described herein may be implemented as methods, systems, devices, or combinations thereof. Accordingly, the following detailed description is illustrative in nature, and the scope of the present disclosure is defined by the appended claims and their equivalents.

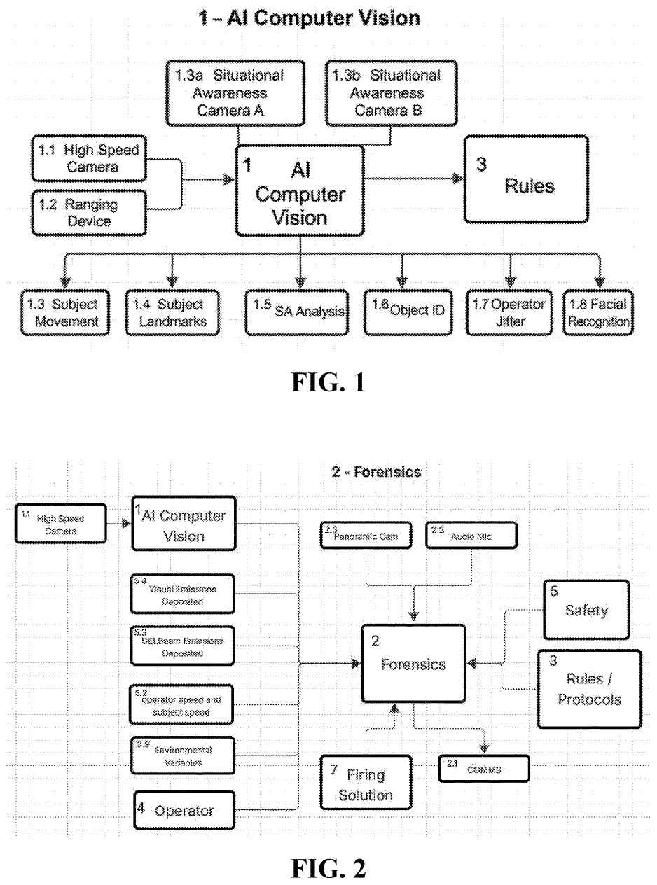

As shown in FIG. 1, an AI Computer Vision engine [1] acquires image or video data from one or more imaging devices, such as a high-speed camera [1.1] positioned on the appliance and oriented generally in a direction corresponding to one or more emitted beams. The AI Computer Vision engine analyzes captured image data to identify subject anatomical locations [1.4], which may include regions such as the head, torso, arms, hands, legs, or feet, as well as facial features, including the nose, mouth, lips, teeth, tongue, gums, and/or eyes, including the corneal region. Landmark identification may be performed on a per-frame basis or across sequences of frames.

A Time-of-Flight (ToF) ranging device or set of depth perception cameras [1.2] measures a distance from the appliance to an object or subject being aimed at or pointed toward, in one implementation at a measurement rate of approximately 100 Hz. Range data generated by the ToF ranging device is provided to the Rules and Protocols Engine [3] and is used for functions including object or subject tracking, as well as for controlling a variable optics system capable of modifying a focal point of interdiction [7.3] of a directed energy laser (DEL) beam and a visual obfuscation laser.

In one implementation, advanced computer-vision algorithms employing deep-learning techniques are used to extract landmark information from individual video frames with combined image-acquisition latency and processing time of less than approximately 5 milliseconds. Image acquisition, data transfer to a neural processing unit (NPU), and inferencing and output generation by the NPU collectively produce an end-to-end processing timeline of less than approximately 5 milliseconds. In one embodiment, the high-speed imaging sensor operates at a frame rate greater than 250 frames per second, with initial image-acquisition and data transfer times on the order of approximately 1-2 milliseconds. The imaging sensor may provide high quantum efficiency to reduce required exposure time. Where ambient lighting is insufficient for image analysis, visible or non-visible supplementary illumination may be utilized.

Simultaneously, the AI Computer Vision engine analyzes video data from the high-speed camera [1.1] or other lower frame rate situational awareness camera(s) [1.3a], [1.3b] to provide situational context [1.5] by capturing sequences of images that reveal dynamic insights into actions. In one embodiment, the number of subjects present and their movements are analyzed as part of threat assessment. In another embodiment, tracking a subject across multiple frames allows for analysis of behavior and prediction of subsequent actions. Monitoring changes in human pose over time facilitates action classification. In another embodiment, the situational awareness cameras [1.3a], [1.3b] can be used in a stereoscopic manner to provide 3-D depth perception which can be feed to the variable optics focusing lens to control the DEL beam and the Visual Obfuscation beam spot size. The situational awareness camera(s) [1.3a], [1.3b] along with the high-speed camera [1.1] can be used in tandem to provide a greater Field of View, detection of multiple individuals within the field of view, object and pose detection, velocity measurements of the individuals, while the high-speed camera is used for precise anatomical and landmark targeting of the specific subject of interest. The situational awareness cameras [1.3a], [1.3b] along with the AI system, can be used to track control a gimbal which would enable the horizonal and vertical orientation of the DEL and Visual Obfuscation to direct the lasers to interdict to a specific subject in a Field of Regard, or to many subjects in the Field of Regard.

The AI Computer Vision engine also captures object features to support subject tracking and Object ID generation [1.6]. In one embodiment, weapons are detected and the resulting information is forwarded to the Rules and Protocols Engine [3] to influence interdiction behavior. In another embodiment, facial recognition [1.8] is used to classify subjects as Unknown, Known Good, or Known Bad. This classification is used by the Rules and Protocols Engine to govern Emission Signature [6] and Firing Solution [7] behavior.

When multiple subjects are present, multi-subject tracking (MTT) is used to manage relationships between detections and tracks. In combination with the ranging device [1.2], the AI engine may remain locked onto a selected subject to reduce collateral impact while maintaining persistent tracking and interdiction. Audible, acoustic, or haptic feedback may be used to inform the operator that a valid subject is being tracked.

The AI engine continuously analyzes all objects within the field of view. Only the subject aligned with a GuideStar visible wavelength sensor (or a pointing and alignment reference, physical or virtual, used by the AI Computer Vision system to designate a single active subject for interdiction while allowing other subjects to remain tracked by situational awareness sensor(s)) is considered the active or targeted subject; however, all persons and animals in the background are tracked for situational awareness. Distances to non-aligned objects are estimated using computer-vision algorithms. Alerts may be generated if a person or animal rapidly approaches the operator.

The Rules and Protocols Engine [3] ingests AI-derived data and user input to generate a firing solution defining beam-steering and power-management settings. Subject-range information is used to control focal-point settings and to enforce operational distance constraints.

As shown in FIG. 2, a Forensics Engine [2] securely records variables and parameters generated by the Rules and Protocols Engine [3] and the Safety Engine [5], as well as environmental conditions including temperature, humidity, and ambient light. In some implementations, the Forensics Engine may also record video from a panoramic camera and audio from a microphone to support situational awareness, after-action reporting, and real-time or near-real-time decision making.

In one implementation, a microphone [2.2] continuously records audio using a circular FIFO buffer having a duration of approximately 60-6000 seconds. When the appliance is unholstered or emits a directed energy laser (DEL) beam or visual obfuscation beam, the buffered audio is stored and associated with a corresponding incident until the appliance is shut down or re-holstered.

In another implementation, a wide-angle panoramic camera [2.3] records video when the appliance is unholstered or emits laser energy. The panoramic camera can be mounted in the appliance or remotely mounted as well as flown. Still images and/or snapshots from the high-speed camera [1.1] may be captured when emissions are engaged or disengaged. In one embodiment, the snapshots include overlays such as landmark bounding boxes, and in another embodiment, raw image data is stored without overlays.

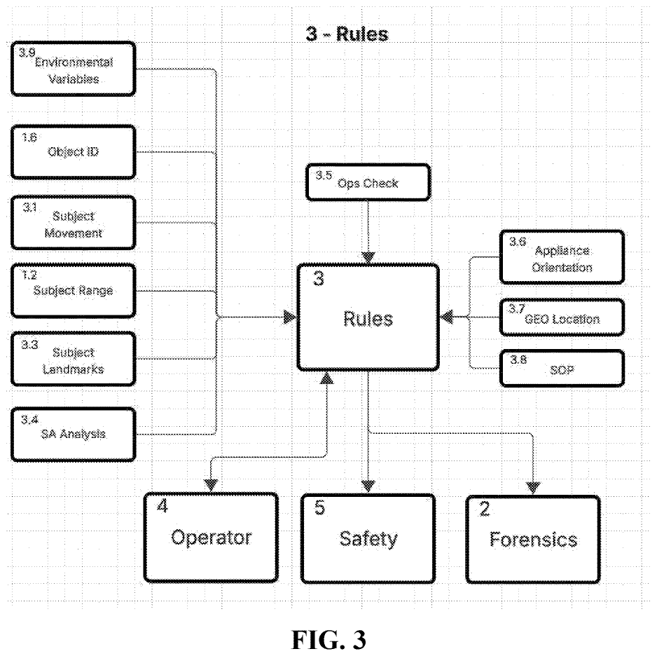

As shown in FIG. 3, a Rules and Protocols Engine [3] receives input and stores the metadata from multiple sensors, subsystems, and derived data sources to govern operational behavior of the appliance. Environmental variables [3.9], which may be derived from one or more environmental sensors or other data sources, can represent ambient conditions such as light level, temperature, humidity, atmospheric conditions, or related contextual factors, and provide input that may influence emission-signature calculations or other operational constraints. An appliance-orientation input [3.6], which may be derived from an inertial measurement unit (IMU), gyroscope, accelerometer, or equivalent orientation-sensing mechanism, may be evaluated to determine whether the appliance is oriented in a potentially unsafe direction, including, by way of example, toward aircraft or other protected objects or zones.

Metadate including, for example, emissions data, GPS, operator ID, atmospheric conditions, is retrieved from the Safety Engine [5] and timestamped using a real-time clock. Forensic data is secured both at rest and in transit to preserve chain of custody. In some implementations, the data may be uploaded to a central command center using secure communications [2.1], such as via cellular, Wi-Fi, or Bluetooth links. Management systems may receive alerts upon appliance use and may remotely activate, deactivate, or configure one or more features of the appliance. In another embodiment, the metadata can be stored in a separate file locally or remotely. In another embodiment, the metadata can be embedded in the video footage itself together with a SMPT code, thus providing an enhanced level of tamper-proofing the recorded evidence.

Geolocation data [3.7], which may be obtained from a GNSS receiver or other location-determination mechanism, may be used by the Rules and Protocols Engine to modify emission behavior when the appliance is operated within, or enters proximity to, restricted, sensitive, or regulated environments, such as hospitals, airports, or other controlled locations. Protocols or standard operating procedures [3.8] define how the appliance responds to detected objects or weapons, subject movement, distance or range measurements, situational-awareness outputs, and, in some implementations, operator interaction. The appliance may further perform periodic operational or self-checks [3.5], including during power-up, removal from a holster, or other state transitions, with results communicated via one or more feedback modalities, such as acoustic, haptic, or visual indicators, and recorded by the Forensics Engine [2] for subsequent analysis or review.

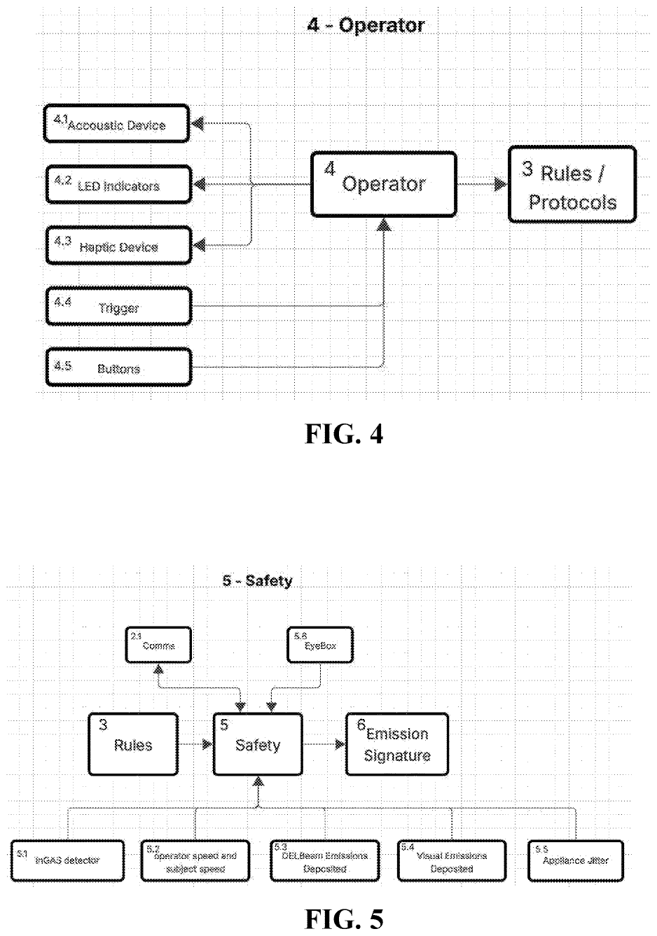

As shown in FIG. 4, an operator interacts with the appliance via one or more control inputs, such as a trigger [4.4] and buttons [4.5], while receiving status or condition feedback through one or more output interfaces, including an acoustic device [4.1], LED indicators [4.2], and/or a haptic device [4.3]. In one embodiment, activation of a trigger initiates an engagement request, which may result in directed energy laser (DEL) emission toward a location at which the appliance is oriented, subject to approval by a Safety Engine [5]. In another embodiment, laser emission is permitted only when the Rules and Safety Engines jointly determine that a valid region of interest has been identified, thereby reducing or eliminating reliance on precise manual aiming by the operator

In a further embodiment, the appliance operates in an assistive or semi-autonomous mode in which the Rules and Protocols Engine selects or prioritizes a region of interest based on contextual information, such as prior engagement history, observed subject behavior, and object detection or classification outputs. In some implementations, biometric authentication or user-verification mechanisms may be integrated into the trigger [4.4], buttons [4.5], or other operator interface components to restrict operation of the appliance to authorized users.

As shown in FIG. 5, a Safety Engine [5] monitors one or more laser emission characteristics, which may be measured using an optical power detector, such as an InGaAs detector [5.1], and evaluates the measured output energy and can adjust the energy relative to predetermined or dynamically adjustable safety criteria. Energy deposited per emission event, per release, or per engagement incident may be calculated using inputs such as DEL beam emissions deposited [5.3] and visual emissions deposited [5.4] and assessed to maintain compliance with applicable safety limits. Based on this evaluation, the Safety Engine may dynamically adjust an Emission Signature [6] and a corresponding Firing Solution [7] to tightly control the total energy delivered to one or more anatomical regions or spatial locations.

In one embodiment, a virtual EyeBox [5.6] is defined in association with a subject region corresponding to the eyes, within which laser emissions are restricted, inhibited, or subject to heightened control. The size, shape, and position of the EyeBox may vary dynamically based on factors including distance to the subject, subject motion, operator movement, and appliance jitter [5.5]. In some implementations, visual or non-damaging optical emissions may be deployed prior to, or in coordination with, DEL emissions to induce protective physiological responses, such as an involuntary blink reflex, as an additional safety mechanism.

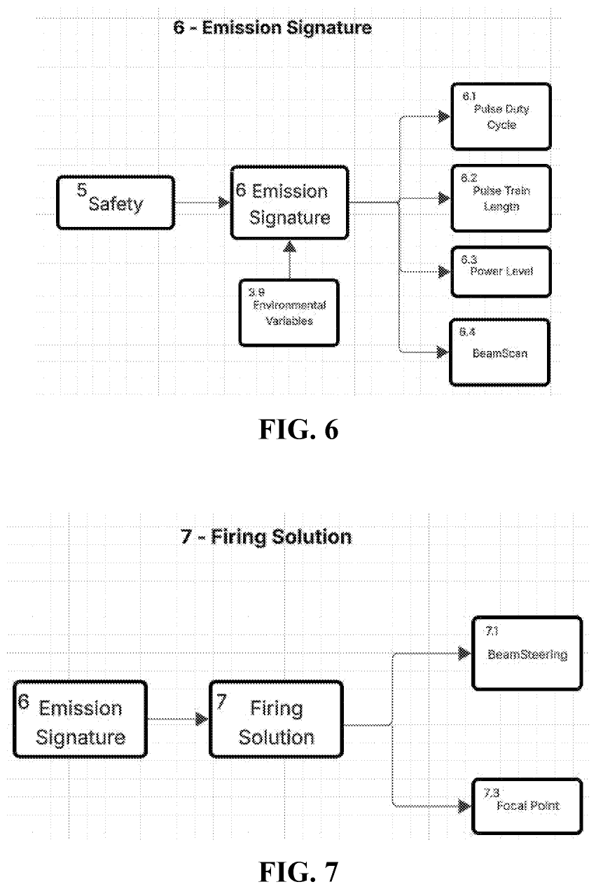

As shown in FIG. 6, an Emission Signature Engine [6] defines laser emission parameters, which in some implementations may include pulse duty cycle [6.1], pulse train length [6.2], power level [6.3], and beam-scanning behavior [6.4]. Emission signatures may be adjusted based on factors such as environmental conditions, observed subject response or compliance, and anatomical sensitivity of a selected region of interest

In one embodiment, beam scanning introduces controlled motion of the laser beam to distribute delivered energy over a larger area, thereby reducing the likelihood of injury while still producing a desired deterrent or sensory effect, such as pain. Scanning may be performed using electronically controlled micromirrors or by optical elements actuated through electromechanical, acoustic, or optical mechanisms.

As shown in FIG. 7, a Firing Solution [7] generates commands to aim, focus, and steer a GuideStar visible wavelength laser, a directed-energy laser (DEL) beam, and one or more visual obfuscation beams. A beam-steering subsystem [7.2] may utilize micromirrors, galvos, or similar devices to decouple beam placement from the physical orientation of the appliance. This configuration may allow emissions to be precisely deposited on selected anatomical regions even while the appliance itself is oriented differently. The controlled emissions are delivered toward the subject without physical contact, including without requiring mechanical or bodily contact with the subject, and may comprise radiative or wave-based energy emissions, such as photonic, acoustic, electromagnetic, or similar propagated energy, regulated by the control circuitry to satisfy predetermined safety and operational constraints, as described herein.

In one implementation, a focal-point control engine [7.3] adjusts beam focus based on subject-range data received from a Time-of-Flight ranging sensor. In one embodiment, focal adjustment is achieved using an electromechanical liquid lens. In another embodiment, one or more lenses are positioned along an optical track to achieve a desired focal distance.

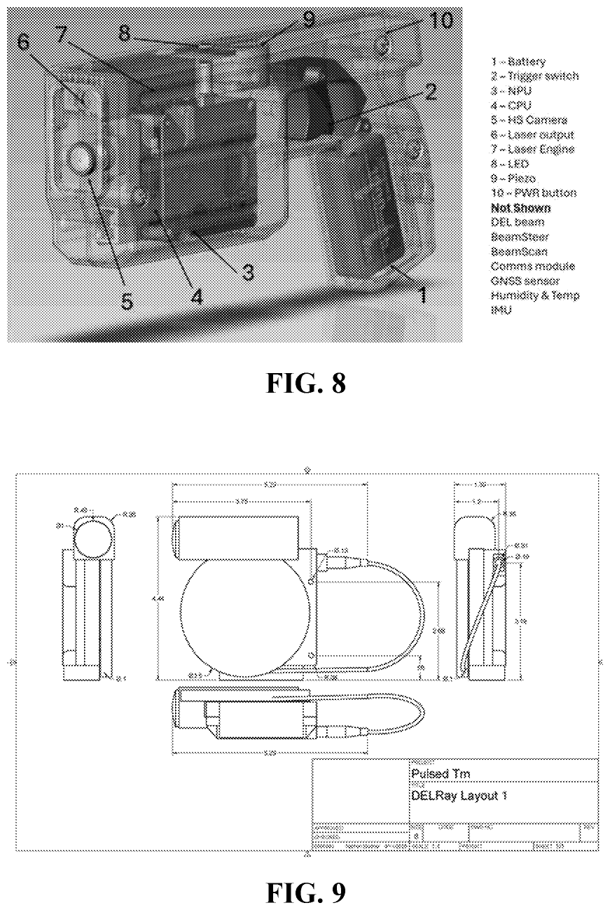

As shown in FIG. 8, the appliance comprises a handheld form factor defined by an external mechanical layout and dimensional configuration that supports ergonomic operation. The layout accommodates internal optical, sensing, processing, power, and communication components, while enabling persistent tracking, emission control, safety enforcement, and forensic recording during interdiction events.

As shown in FIG. 9, an optical subsystem is integrated within the appliance and includes one or more laser sources, beam-combining elements, variable-focus optical components, and beam-steering elements. The optical subsystem supports both directed energy laser (DEL) emissions and visual obfuscation emissions and may be configured to operate at multiple wavelengths, provide adjustable spot sizes, and enable dynamic focusing across varying engagement distances.

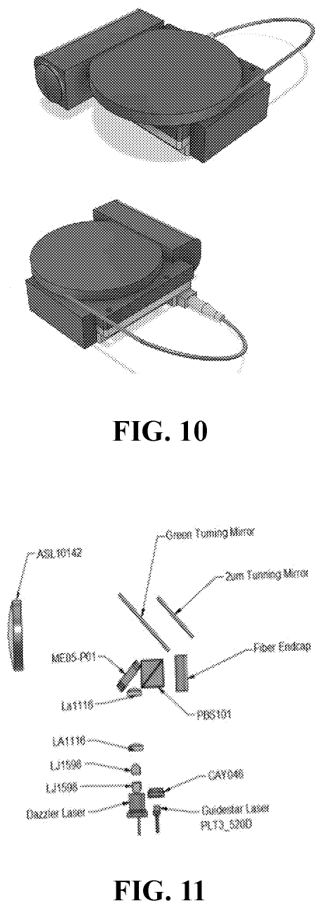

As shown in FIG. 10, the instrument includes a pulsed directed-energy laser (DEL) source configured to generate laser emissions for controlled energy delivery as described herein. The DEL source may comprise any laser or optical energy source capable of producing controlled, pulsed emissions suitable for the applications described herein. In one embodiment, the DEL source comprises a thulium (Tm)-based pulsed laser; however, other laser gain media, pulse formats, and wavelength regimes may be used depending on operational, safety, and application requirements.

As shown in FIG. 11, the DEL source is coupled to an optical emission and beam-delivery subsystem that includes variable optical elements and beam-steering components. The optical emission and beam-delivery subsystem is configured to enable controlled focusing, shaping, and directional delivery of laser emissions toward selected regions of interest.

In one embodiment, a visible wavelength GuideStar (pointing) laser beam can illuminate a small spot on the subject or on an area in close proximity to the subject as aimed by the operator. The beam is sufficiently visible as to cause the subject to look at the beam. As the subject becomes fixated on the visible beam, as to cause the subject to be focused on that spot. At the same time, a 2nd non-invisible emission is activated on the cornea to cause the ultimate burning pain sensation which is not co-aligned with the 2 μm DEL. The process of activating the nociceptors on the cornea requires seconds of time to raise the temperature safely as to initiate and produce an extreme pain sensation, as such, the subject must be visually and cognitively overloaded with other stimuli otherwise, the subject will begin to feel an unusual sensation on their eyes and will turn away from the operator. Acoustic stimuli can also be used to mask the oncoming pain in the subjected eyes.

In one embodiment, during operation, the instrument is aimed at the subject. For covert operations, a non-visible GuideStar (pointing) beam can illuminate a small spot on the subject, giving feedback to the operator who is equipped with specialized night-vision gear that they have the subject identified visually. At that moment, feedback is presented to the operator that the subject is locked in the CV system and can automatically track them with a 25-degree Field of View (FoV) with the built-in Firing Solution.

In one embodiment, the operator may be using the instrument in a covert operation. The targeting or GuideStar visible wavelength laser beam would thus be in an invisible wavelength eluding the subjects' awareness of being sited by the operator. In both the visible and invisible applications, once the operator has aimed and confirmed the subject/target by visual means, the AI Computer Vision system locks on to the subject and persistently tracks the subject/target. The operator would either receive confirmation that they are locked on the target. This confirmation may come in the form of haptic, LED activation or acoustic. As such, the operator would not be required to wear night-vision gear.

In one embodiment, if a bystander were to cross the engagement field, the system would be prevented from depositing emissions

In one embodiment, other anatomical ROI can be targeted. Although the epidermis (skin) is also a target location for thermal stimulation, it is often covered by specialized clothing as the subject is intent to carry out their mission of harm. DEL emissions can penetrate a broad range of clothing, the greater the porosity, the greater the efficacy to prosecute and deposit energy on the epidermis itself.

In one embodiment, the hands of the subject may be protected by a glove making them an unlikely target ROI. The AI Computer Vision system engine will acquire an ROI and guide the operator by automatically repositioning the GuideStar visible wavelength laser where to deposit emissions on the subject, evaluating many areas on the body, and can autonomously deposit emissions on the arm, chest, neck, lips, mouth, nose, and the eyes.

In one embodiment, the instrument can incorporate a hyperspectral or multispectral camera. Hyperspectral cameras can detect both exposed skin and skin covered by clothing because they capture data across a wide range of wavelengths, including near-infrared (NIR) light, allowing them to see through certain materials like clothing. This specialized camera can also recognize smoke as well as fire. In operation, the DEL emission level could be increased to penetrate clothing. In one example, the clothing may be porous, in which case the DEL can stimulate the epidermis, increase its temperature and induce pain. In another example, the clothing may be synthetic and catch fire. The hyperspectral or thermal camera would determine if the emission location was unusually warm, a precursor the synthetic material is about to melt. Under this situation, the DEL emission power could be reduced.

In one embodiment, the optical design of the system produces a sweet spot for interdiction distance, meaning the beam size is 1 mm on target as measured by the ToF sensor. The ToF ranges the subject and electronically controls the focus for the variable optics lens, thus optimizing beam size for the subject at various distances. The optical design produces maximum power on target, while a larger spot size of 2-3 mm is produced 24 inches in front of and behind the target. The beam is thus out of focus on either plane of the subject, making the emissions harmless as the beam has diverged sufficiently. If another person, animal, or motor vehicle were to pass in the emission field, they would not experience the interdiction effect as they are out of focus.

In one embodiment, the AI Computer Vision engine is configured to adjust the Emission Signature to induce the necessary behavioral change based on the target anatomical area.

In one embodiment, a high-speed scanning beam steering system (galvo) operating in the range of 5,000-40,000 PPS is used. Using this scanning system coupled to the AI Computer Vision system, energy is initially deposited on the targeted tissue using an approximately 1 mm spot size, 1-2 ms pulse to cause a low thermal response while not inducing any permanent tissue damage. The emissions energy is not sufficient to induce sufficient pain to cause a change in behavior. A second dose of energy is then deposited on a location approximately 3-5 mm in distance from the initial energy deposited. This protocol can be repeated. This approach fulfills the MPE safety guidelines as no single dose of energy is deposited on the tissue at the same location. A human and/or an AI Computer Vision system monitors the subjects' reaction to the stimuli and determines if the interdiction efficacy is meeting its objective. This process continues until the subject is dissuaded from their actions.

This approach limits exposures to any spot on the eye or skin to levels below the MPEs for the duration of a single pulse through durations lasting up to the entire application period.

In one embodiment, repeated emissions are intentionally aimed so as not to deposit emissions on the same location.

In one embodiment, as an example, using a static 2 μm, 1 mm beam, a diffractive optical element (DOE) incorporated into the DEL design produces multiple stimuli emissions on the target concurrently. It provides for the DEL energy to be distributed over a larger area so as to activate a greater number of nociceptors, aggregating the individual DEL stimuli to achieve a greater level of pain without inducing tissue necrosis. A human and/or an AI Computer Vision system monitors the subjects' reaction and determines if the process is meeting its objective and could emit additional doses of laser energy. This approach limits exposures to any spot on the eye or skin to levels below the MPEs for the duration of a single pulse through durations lasting up to the entire application period.

In one embodiment, a moveable lens in the firing solution may be powered by an electromechanical, acoustic, or optical means to oscillate and/or vibrate, enhancing the distribution of laser emissions resulting in a larger distribution of energy, resulting in aggregating the individual nociceptor branches to create a greater level of pain intensity on the generalized targeted region without the risk of inducing tissue necrosis.

In one embodiment, a human and/or AI Computer Vision system monitors the subjects' reaction and determines if the process is meeting its objective. This approach limits exposures to any spot on the eye or skin to levels below the MPEs for the duration of a single pulse through durations lasting up to the entire application period.

In one embodiment, a lens in the firing solution incorporates a multi-apertures array, enhancing the distribution of laser emission resulting in a larger distribution of energy, in addition to aggregating the individual nociceptor branches, to create a greater level of pain intensity on the generalized targeted region without the risk of inducing tissue necrosis. A human and/or an AI Computer Vision system monitors the subjects' reaction and determines if the process meets its objective. This approach limits exposures to any spot on the eye or skin to levels below the MPEs for the duration of a single pulse through durations lasting up to the entire application period.

In one embodiment, a multi-branch fiber optic bundle or laser combiner can split the light into separate output areas of emissions, allowing for the distribution of laser energy to multiple destinations that are contained in the firing solution. The divergence of each fiber aperture is maintained and runs parallel to its adjacent aperture, meaning the emissions run parallel to the adjacent aperture. In this approach, multiple locations of energy are deposited on the epidermis on the various nociceptor branches, inducing the requisite pain response to ensure behavior modification. This approach limits exposures to any spot on the eye or skin to levels below the MPEs for the duration of a single pulse through durations lasting up to the entire application period.

In one embodiment, an electromechanical oscillation device or vibrating piezo mechanism or other means may be used to enlarge the distribution of emissions and activate additional nociceptor branches. A human and/or an AI Computer Vision system monitors the subjects' reaction and determines if the process meets its objective. This approach limits exposures to any single region on the eye or skin to levels below the MPEs for the duration of a single pulse through durations lasting up to the entire application period, while distributing the emissions across a greater area to stimulate a greater number of nociceptors and induce the desired response from the subject to de-escalate or leave an area.

In one embodiment, the system is designed to deposit emissions on a generalized target location or at different generalized target locations on the subject. A dose of energy is deposited and with each successive emission, the stimulus is either maintained or escalates. In doing so, multiple degrees of sensations can be elicited from the subject ranging from: mildly aware, annoying, discomfort, sharp needle-like pricks to extreme pain. This escalating emission signature could be preprogrammed or can be manually adjusted by the operator of the system. Using this approach, the novel instrument would serve a wider use case, as every subject has their own perception of pain, and a one-size-fits-all model may not be the best solution for every incident. This approach limits exposures to any spot on the eye or skin to levels below the MPEs for the duration of a single pulse through durations lasting up to the entire application period.

In one embodiment, the system is designed to deposit emissions on the same location or at different locations of the subject, with each successive emission applied with the same dose or an increased dose of energy. In doing so, multiple degrees of sensations can be elicited ranging from: mildly aware, annoying, discomfort, sharp needle-like pin pricks to extreme pain. This escalating emission signature could be preprogrammed or manually adjusted by the operator of the system. Using this approach, the novel instrument would serve a wider use case, as every subject experiences their own perception of pain, and a one-size-fits-all model may not be the best solution for every incident. This approach limits exposures to any spot on the eye or skin to levels below the MPEs for the duration of a single pulse through durations lasting up to the entire application period.

In one embodiment, the system can be programmed not to exceed a specific aggregated energy emission or limit the number of emissions that may be produced or time out. In another embodiment, the system can be programmed not to exceed a specific aggregated energy emission or limit the number of emissions that may be produced based on the venue in which the instrument or system is operated, the qualifications of the operator, the jurisdiction, rules of engagement, state or federal laws, or by the customer. This approach limits exposures to any spot on the eye or skin to levels below the MPEs for the duration of a single pulse through durations lasting up to the entire application period.

In another embodiment, the system may be designed to aim at the eye(s) using a DEL or a visible laser. The AI system can detect an object such as a firearm and make the decision the optimum de-escalation is to obfuscate the subjects vision or to induce pain into the eye.

In one embodiment, the system is designed to deposit emissions on the same location or at different locations of the subject, with the initial emission on each target area designed to pre-treat each anatomical target location to induce hyperalgesia, a medical symptom characterized by increased sensitivity to pain, where painful stimuli are perceived as more intense than usual, or where stimuli that are normally not painful become painful. In practice, following the initial emission, a second dose of energy emission is deposited on the same target location. The second or follow-on emissions can be lower, the same, or greater in joules/cm² than the pre-treat dose. Each successive emission on the same area exacerbates the hyperalgesia state, increasing pain sensitivity even if the subsequent dose is the same or lower than the initial dose. This results in unbearable pain for the subject, causing the subject to relent. Using this protocol ensures no permanent tissue damage is experienced by the subject. This approach limits exposures to any spot on the eye or skin to levels below the MPEs for the duration of a single pulse through durations lasting up to the entire application period.

In one embodiment, the DEL emission can be directed or constrained from emitting onto specific anatomical regions of the body. Such is the case of preventing any laser energy emissions into the eye(s), including the orbital socket, periorbital area, and surrounding areas including the forehead, nose, nasal mucosa, vermillion, lips and mouth, chin, cheeks, and ears.

In one embodiment, using the AI Computer Vision system, the ability to prevent the deposition of emissions on a particular region is enabled. Using beam steering, the anatomical target zone is locked in, such that if the subject and/or the operator move, the beam is adjusted and steered to the region of interest (ROI) on the body available for interdiction as established by the operator or the AI Computer Vision system.

In one embodiment, the DEL emission power can be adjusted based on the anatomical target region. As an example, the eye contains a significantly greater number of nociceptors than any other anatomical area on the body. In this example, the emission dose required to induce immense pain when targeted on the eye is a far lower energy level than that required to induce pain on the palm. As such, the AI Computer Vision engine is configured to adjust the Emission Signature to induce the necessary behavioral change based on the target anatomical area.

In one embodiment, the AI Computer Vision system, Emission Signature, Beam Steering, and Variable Optics systems can control a laser emission in a variety of wavelengths, both visible and non-visible.

In one embodiment, the instrument incorporates a “free-to-fire” protocol, releasing and persistently depositing the laser emissions on the precise location of the target to cause pain as governed by the AI Computer Vision system. As an example, once the operator locks on to the subject, even by aiming and depressing a trigger switch, the subject is followed within the camera field of view (FOV). The appliance considers the subject's behavior, dress, whether they are wearing sunglasses, whether they are carrying a weapon, etc. The appliance then determines where on the anatomy and when to release the deposited emissions on the subject, even if the subject is running. Alternatively, the instrument can be manually triggered by the operator. Upon the laser emissions'thermal excitation on the subject's epidermis or cornea, the subject is immediately overwhelmed with pain, preventing or incapacitating their movement. In such case, for example, the DEL wavelength has been selected (chosen) not to be injurious to the retina as the thermal impact to the eye is mitigated by the aqueous fluid in the eye cavity.

In one embodiment, the instrument incorporates an “overwhelm” protocol, releasing and persistently depositing the laser emissions on the precise location of the target to cause pain as governed by the AI Computer Vision system. As an example, once the operator locks on to the subject, even by aiming and depressing a trigger switch, the subject is followed within the camera FOV. The appliance considers whether the subject is wearing sunglasses, as the AI Computer Vision system can detect sunglasses and adjust the Emission Signature accordingly. The appliance deposits emissions on the subject, monitors their behavior based on the protection the eyewear offers, and continues to escalate the emission level until the subject succumbs.

In one embodiment, depositing DEL emissions on the eye suffices to induce pain and produce tearing, causing the subject to reflexively use their hand to cover that eye area, as well as to rub the area. Depositing emissions onto both eyes to induce pain causes the subject to reflexively use both hands to protect their eyes. The pain induced is incapacitating and has been termed corneal pain incapacitation. In a general sense, this pain deprives the subject of their ability, strength, or capacity to perform a task or function, quickly succumbing to behavior modification.

In one embodiment, the AI Computer Vision system would identify a firearm and alert the operator. Based on the Rules Engine, this may cause depositing DEL emissions in both eyes to induce pain and causes the subject to reflexively use both hands to protect their eyes. The subject holding a weapon would drop the weapon to attempt to protect and cover up their eyes.

In one embodiment, the AI Computer Vision system monitors the behavior of the subject prior to the interdiction, during the interdiction, and after the interdiction. Based on the subject's behavior, the system incorporates persistent protocol targeting, tracking, and interdiction. In one example, the subject would be interdicted with their initial emission being deposited on their right hand. Assuming the subject continued to approach the operator as measured by the CV system, the time-of-flight (ToF) sensor and/or by the decision of the operator, the system would deposit a second dose of emissions on the subject's left hand. This process could continue on other ROIs of the subject until they relent.

In one example, the persistent protocol could increase the dose of emissions with each successive deposition, thereby escalating the level of pain experienced by the subject. This process would automatically be repeated until the subject relents. Both the emission dose can be escalated on the same ROI of the subject as well as new additional ROIs incorporated in the persistent engine protocol.

In one embodiment, the DEL is enabled to control the maximum number of emissions per incident regardless of how many times the trigger is pulled.

In one embodiment, the DEL is enabled to provide a recovery period, in effect disabling the emissions of the appliance for a period of time, which can be included as part of the rules engine defined below. This recovery period would prevent the overuse of the instrument on a subject.

In one embodiment, the appliance would be integrated with a taser, or a firearm, such that the operator would only have one instrument to carry.

In one embodiment, the appliance would be integrated with noxious or lacrimal agents as well as other non-lethal countermeasures, such that the operator would only have one instrument to carry.

In one embodiment, the AI Computer Vision engine can be used to control other non-lethal and lethal weapon systems.

In one embodiment, the appliance would deposit an emission signature to write a QR, UPC, or other graphic image incorporating GPS details and time details on the tissue using the beam scanner. This would cause temporary human branding or stigmatizing. This is the process by which a mark is burned into the skin of a living person, with the intention of resulting in atheroma to cause a temporary pattern on the epidermis. This would allow law enforcement to visually site individuals and confirm their location where the atheroma was induced. The tissue would heal, for example, within days and the atheroma, for example, would be completely resolved.

In one embodiment, the appliance would deposit an emission signature to write a QR, UPC, or other graphic image incorporating GPS details and time details on the tissue using the beam scanner. This would cause temporary human branding or stigmatizing. This is the process by which a mark is burned into the skin of a living person, with the intention of resulting in a permanent scar on the subjects' tissue. This would allow law enforcement to visually site individuals and confirm their location where the scar was induced. The tissue would heal, for example, within days and the atheroma, for example, would be completely resolved.

In one embodiment, photonic disruption, ablation, and destruction using directed energy lasers designed to induce psychological and behavioral modification, long-term tissue and organ damage produced by the instrument. The DEL and its signatures would be optimized to enable the desired DEL effect.

In one embodiment, photonic disruption, ablation, and destruction using directed energy lasers incorporate with the ultra-fast AI Computer Vision engine that can be flown, fixed, watercraft, or robotically deployed as an integrated or modular system.

In one embodiment, the AI Computer Vision system can intercept UAVs by targeting, tracking, and aiming the DEL at the vision sensors of the UAV to destroy them with heat so as to eliminate visual guidance of the UAV.

In one embodiment, the AI Computer Vision system can predict the current position of the subject and forecast the next body position based on the last few seconds of pose and position analysis. The targeting, tracking, and aiming positioning will be updated to increase interdiction location confidence.

In one embodiment, at the time a subject is interdicted with laser emissions, the AI Computer Vision system is evaluating the effectiveness of the emission to induce a change of behavior. Based on the subject's updated pose and/or location and/or distance, the emission may persist until the desired behavior is achieved. Examples of pose would include the subject raising one or both of their hands, turning away from the operator, or turning their back toward the operator. In another example relating to location, the subject can begin to move from a 3:00 o'clock position to a 12:00 o'clock position from the operator. The AI Computer Vision system provides overwatch of the subject's behavior and may choose to continue to interdict if required.

In one embodiment, a forensics engine is incorporated. The instrument can be activated in many ways, including by the drawing of it from its holster, from the speed, direction, and location at which it moves. As another example, it can be activated by a proximity switch located on the operator, such that the instrument becomes aware based on distance from the operator as measured in inches. As another example, it can be activated by voice command or by other resources such as a body cam. It can also be activated manually. There are many other enabling technologies that would activate the instrument. In another embodiment, the DEL system could be activated by a laser designator carried by another licensed operator.

Once active, the instrument automatically records all events, including storing to memory the last 60 seconds of the audio FIFO buffer that has been running 24/7. It records the GPS location of use, ambient temperature, system temperature, humidity, lumen level, battery level, communications integrity, frame rate, operator ID from the biometric sensor, panoramic video, high-speed camera data, laser emissions time, laser emission dosage time-on-target, audio exchange with the operator and the subject, the interaction location on the subject, and the subject's response. It can also visually and acoustically record the after-action report. The data can be stored and uploaded automatically or manually to a central repository.

In one embodiment, the operator does not have direct line of sight to the subject, as the operator is protecting themselves behind the corner of a brick wall from a subject carrying a weapon. The operator can point the appliance in the general area of the subject while being shielded from the subject. The AI Computer Vision system would analyze the subject's stance, distance, and dress and automatically send interdiction coordinates to steer the beam to the precise location, equivalent to “seeing around the corner.” The subject has no knowledge that they are being targeted by the appliance, as the laser wavelength is invisible. The interdiction may be automatic or manual, and the subject would immediately experience pain. The operator would achieve the same level of target accuracy as an expert marksman, even while protected from being fired upon.

In one embodiment, the AI Computer Vision system would analyze, for example, the subject's stance, distance, dress, beard, eyewear, and determine where the emissions would best be targeted on the subject's anatomy. The appliance would then steer the beam to the precise location or locations on the target to begin depositing emissions. The emission dose could escalate with each successive emission.

In one embodiment, the operator directs the appliance to interdict the center of the subject's mass, in the same fashion the operator has been trained to aim a firearm. The AI Computer Vision system would analyze the subject's stance, distance, and dress and determine where the emissions would best be targeted. The appliance would then automatically steer the beam to the precise location or locations on the target to begin depositing emissions. The emission dose could escalate with each successive emission.

In one embodiment, the operator directs the appliance to obfuscate the subject's vision. The appliance includes either green, red, blue laser, or a combination of visible wavelength lasers. These lasers are designed to temporarily compromise or obfuscate the vision of the subject and induce the initial behavioral modification state of de-escalation. It accomplishes this using various visible wavelengths that are pulsed and timed to interrupt the central nervous system, thereby inducing visual disorder and cognitive load on the subject. It is very disturbing to experience. The process also includes a means to escalate the power, intensity, flicker rate, wavelengths, and patterns. It also includes a process to escalate one or more of these variables based on distance, such that the closer the subject travels toward the operator, the more severe the obfuscation becomes, thereby de-escalating the situation. The AI Computer Vision system enables the obfuscation emissions engine to track the face, movements, and direction of the subject to persistently track and interdict with visible laser emissions. This is enabled by the ToF measuring distance, controlling the variable optics lens, and laser power drivers to keep the energy profile, as well as beam steering enablement to track the subject's movements.

In another embodiment, the operator directs the appliance to deposit DEL emissions on the nose, lips, and chin, but not on the eyes. An additional layer of safety is enacted, and prior to the DEL emission, a short 50 ms pulse of visual wavelength emission is directed at the subject's eyes, causing an involuntary blink reflex. The AI Computer Vision system camera can witness the eyelids closing, at which time it then deposits DEL emissions on the target areas of the face. The CV system records all of this video content, targeting, and emissions information. This enhances the trail of evidence that may be needed in court to prove that the subject was not subjected to DEL emissions in their corneas using photographic images.

In another embodiment, the appliance is equipped with a biometric sensor. In practice, it could be a fingerprint sensor, facial recognition, voice recognition, iris detection, or other. The purpose of the sensor is to eliminate the possibility that the subject or others who are not authorized to use the appliance, should it fall into the wrong hands, could operate it. The biometric sensor has the potential for many dozens to be authorized for use of the appliance, such as where the appliance is shared among many users on different shifts. This biometric ID may be stored in the metadata file.

In one embodiment, the appliance is equipped with a Rules & Protocols engine. The engine establishes the hard rules that govern appliance operation as viewed from a CONOPS use case. The engine additionally contains the protocols for OPSCON, determining how the appliance functions operationally. The rules are software-driven and may be modified by management prior to the appliance being fielded, as well as during its operation either remotely or onsite. As the appliance can be deployed across a broad range of use cases, a template of general operating conditions is applied. As an example, should the appliance be utilized in a behavioral health facility, the appliance would conform to power levels and rules of engagement tailored for interdicting patients who may be deeply medicated and may not respond to photonic stimulus in the same way as a perpetrator breaking into a data center.

In one example, the appliance's visible navigational laser would be prevented from operating on or near an airport, as the visible laser emission could cause a pilot to become startled while operating in the cockpit. The Rules engine has a variety of sensors from which it acquires knowledge. One of the sensors is a GPS system. The GPS system informs the Rules engine of the appliance's location and modifies appliance behavior to conform to the physical GPS coordinates in which the appliance is operating.

Within the Protocols engine, OPSCON is the key driver. As an example, within a behavioral health facility, there may be junior and senior security personnel based on experience in dealing with that patient community. A seasoned operator may be granted permission in the Rules system, enabled through the internal biometric sensor. Once authorized, the senior operator may operate outside the established general operating conditions of a junior officer. Once authorized, the senior operator may have the capability to induce a greater level of pain to modify behavior than a junior operator.

In one embodiment, the DEL or visible wavelength beam is steered using a fast-scanning engine to enhance the safety of deposited emissions. To evaluate laser exposure safety on the eye or skin, energy is compared to an exposure limit using a limiting aperture. The limiting aperture is specified in the same safety standards that define laser exposure limits. Energy not collected by the aperture is not compared to exposure limits. Accordingly, it is possible to scan the laser beam using a fast-scanning engine or other methods (micromirrors, scanners, etc.) to move the beam across the subject's epidermis or cornea. When scanned with sufficient velocity and amplitude, less laser energy is collected by the limiting aperture. When the maximum amplitude of the scanning beam pattern (pattern size on tissue) is constrained within an effective size to maintain pain induction, a safer product is achieved while retaining effectiveness.

In another embodiment, the visual laser source and lensing is designed to operate as extended source enabling greater safety margin for the visual obfuscation.

In addition, when specifying laser hazard classification of a product, current standards require consideration of two measurement geometries. The first is unaided viewing, simulating observation of the beam with the naked eye. The second is aided viewing, simulating observation with optical aids such as binoculars or telescopes. Safety standards do not require aided viewing evaluation for scanning beams. This may result in a lower hazard classification for the product.

As used herein, a “machine-implemented algorithm” refers to any process, procedure, or set of instructions that is expressly configured to be executed by a computing device, processor, or electronic hardware, and that operates on data stored in tangible, non-transitory computer-readable media. Such algorithms are structurally integrated with the system's hardware and/or software components, including but not limited to processors, memory, data buses, and input/output interfaces, and are not capable of being performed in the human mind or by mental processes alone. A machine-implemented algorithm, as used herein, encompasses steps that require electronic data manipulation, storage, retrieval, and logical operations performed by a computer or other specialized hardware.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described herein generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Embodiments implemented in computer software may be implemented using software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means, including memory sharing, message passing, token passing, network transmission, etc.

The actual software code or specialized control hardware used to implement these systems and methods is not limiting of the methods and embodiments described herein. Thus, the operation and behavior of the systems and methods were described without reference to specific software code, it being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable medium includes both computer storage media and tangible storage media that facilitate transfer of a computer program from one place to another. A non-transitory processor-readable storage medium may be any available medium that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc, laser disc, optical disc, digital versatile disc, floppy disk, and Blu-ray disc, where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present subject matter, e.g., for applications suitable for public and private sectors. Various modifications to these embodiments will be readily apparent to those skilled in the art, and the generic principles defined herein may be applied to other embodiments without departing from the spirit or scope of the subject matter. Thus, the present subject matter is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the claims in this application.

What is claimed is:

1. A system for influencing behavior of a subject at a distance, comprising:
a deployable apparatus positioned remotely from the subject;
at least one subsystem configured to obtain information relating to an environment that includes the subject;
a controllable energy source configured to produce emissions;
an emission delivery arrangement configured to project the emissions toward a location associated with the subject; and
a control circuitry operatively coupled to the at least one subsystem and the controllable energy source, the control circuitry being configured to:
determine, based at least in part on the obtained information, whether emission of the emissions is permitted; and
when emission is permitted, regulate one or more characteristics of the emissions during projection,
wherein the emissions are delivered without physical contact and are regulated to produce an effect on the subject while satisfying predetermined operational constraints.

2. The system of claim 1, wherein the control circuitry is further configured to continuously evaluate the obtained information during projection of the emissions and dynamically modify, permit, or inhibit emission based on changes in subject movement, orientation, or position.

3. The system of claim 1, wherein the control circuitry comprises a rules and protocols engine configured to govern whether emission of the emissions is permitted based on at least one of operator authorization, detected objects, subject behavior, environmental conditions, or predefined operational policies.

4. The system of claim 1, wherein the predetermined operational constraints include dynamically configurable safety constraints that differ based on deployment context, geographic location, or engagement rules.

5. The system of claim 1, further comprising a safety engine operatively coupled between the control circuitry and the controllable energy source, the safety engine configured to actively gate, modify, or terminate emission independent of operator input.

6. The system of claim 5, wherein the safety engine is configured to prevent emission toward at least one restricted region associated with the subject while permitting emission toward one or more non-restricted regions.

7. The system of claim 5, wherein the safety engine dynamically adjusts emission characteristics to comply with exposure limits as a function of subject distance, movement, or orientation.

8. The system of claim 1, wherein the at least one subsystem comprises an imaging sensor and the control circuitry is configured to identify and track the subject using automated analysis of image data.

9. The system of claim 8, wherein the control circuitry is further configured to identify one or more regions of interest associated with the subject and to select a region toward which emission is directed based on the obtained information.

10. The system of claim 1, wherein the control circuitry is configured to persistently track the subject and maintain alignment of the emission delivery arrangement with the selected location while the subject is moving.

11. The system of claim 1, wherein regulating one or more characteristics of the emissions includes controlling at least one of power level, pulse duration, repetition rate, duty cycle, beam size, scan pattern, or time on target.

12. The system of claim 1, wherein the control circuitry is configured to inhibit or suspend emission when another person, animal, or object enters a projected emission path.

13. The system of claim 1, wherein the control circuitry is configured to operate in at least a first mode in which emission toward a specified region is prohibited and a second mode in which emission toward the specified region is permitted.

14. The system of claim 1, wherein the deployable apparatus comprises a self-contained housing integrating at least the controllable energy source, the emission delivery arrangement, the at least one subsystem, and the control circuitry within a handheld or portable form factor.

15. The system of claim 14, wherein the housing encloses optical, sensing, processing, power, and communication components arranged to enable real-time emission control during movement of the apparatus by an operator.

16. The system of claim 14, wherein the at least one subsystem, the control circuitry, and the controllable energy source are co-located within the housing such that emission control is performed without reliance on remote processing or external control infrastructure.

17. The system of claim 1, wherein the control circuitry is configured to determine permissibility of emission prior to initiating projection of the emissions based on real-time analysis of subject context and to maintain or revoke such permissibility dynamically during projection.

18. The system of claim 17, wherein determining permissibility of emission includes evaluating whether a selected anatomical region associated with the subject satisfies defined safety and operational criteria.

19. A non-lethal compliance system for deterring or interdicting a subject, the system comprising:
an appliance configured for handheld or remote operation at a standoff distance from the subject;
an imaging subsystem comprising at least one camera configured to acquire image data of a field of view containing the subject;
one or more processors executing an artificial-intelligence computer vision engine configured to analyze the image data to detect and track the subject and to identify one or more anatomical regions of interest of the subject;
a pulsed directed-energy laser (DEL) source configured to generate controlled photonic emissions;
an optical subsystem coupled to the DEL source and configured to direct, focus, and steer the photonic emissions toward a selected anatomical region of interest;
an emission signature engine configured to define one or more emission parameters including at least pulse duration, repetition rate, power level, beam size, and time on target;
a rules and protocols engine configured to govern operation of the system based on at least one of operator input, subject behavior, detected objects, environmental conditions, or operational constraints; and
a safety engine operatively coupled between the emission signature engine and the DEL source, the safety engine being configured to limit, modify, permit, or inhibit emission of the photonic emissions in accordance with predetermined safety criteria and exposure limits;
wherein, when enabled in accordance with the rules and protocols engine and permitted by the safety engine, the emission signature engine and optical subsystem cooperate to deposit one or more controlled photonic emission doses onto the selected anatomical region of interest sufficient to induce a behavioral response by the subject without requiring physical contact.

20. A system for influencing behavior of a subject at a distance, comprising:
a deployable apparatus positioned remotely from the subject;
at least one subsystem configured to obtain information relating to an environment that includes the subject;
a controllable energy source configured to produce emissions;
an emission delivery arrangement configured to project the emissions toward a location associated with the subject; and
a control circuitry operatively coupled to the at least one subsystem and the controllable energy source, the control circuitry being configured to:
determine, based at least in part on the obtained information, whether emission of the emissions is permitted; and
when emission is permitted, regulate one or more characteristics of the emissions during projection,
wherein the emissions are delivered without physical contact and are regulated to produce an effect on the subject while satisfying predetermined operational constraints.
